(19) United States
(12) Patent Application Publication
(10) Pub. No.: US 2012/0167930 A1
(43) Pub. Date: Jul. 5, 2012

(54) DECARBONIZATION DEVICE

(76) Inventor: Kun-Yu CHEN, Pingtung County (TW)

(21) Appl. No.: 13/333,704

(22) Filed: Dec. 21, 2011

(30) Foreign Application Priority Data
Dec. 31, 2010 (TW) 099225743

(51) Int. Cl. B08B 9/00

(52) U.S. Cl. 134/166 R

(57) ABSTRACT

A decarbonization device for engine decarbonization includes an oxyhydrogen supplying unit, a dryer unit connected to the oxyhydrogen supplying unit, an exhaust unit connected to the dryer unit, and a pressure adjusting unit connected to the exhaust unit. The oxyhydrogen supplying unit is configured to supply oxyhydrogen gas. The dryer unit is configured to dry the oxyhydrogen gas from the oxyhydrogen supplying unit. The exhaust unit is configured to be connected to an engine for providing the oxyhydrogen gas from the oxyhydrogen supplying unit through the dryer unit to the engine. The pressure adjusting unit is configured to provide air into the engine through the exhaust unit so as to adjust inner pressure within the engine.

### CROSS-REFERENCE TO RELATED APPLICATION

This application claims priority of Taiwanese Application No. 099225743, filed on Dec. 31, 2010.

### BACKGROUND OF THE INVENTION

1. Field of the Invention

The present invention relates to a decarbonization device, more particularly to a decarbonization device configured to be connected to an engine for engine decarbonization.

2. Description of the Related Art

Generally, carbon deposits may accumulate in an engine due to poor fuel quality, irregular engine operation, polluted air, etc. When the carbon deposit in the engine accumulates to a certain amount, several problems of the engine, such as unstable fuel supply, reduced efficiency, knocking detonation, vibration, difficulty in starting the engine, flameout, increased fuel consumption, etc., will occur. Therefore, in order to keep an engine operating normally, it is required to perform periodic engine decarbonization for the engine.

There are generally three kinds of methods for engine decarbonization. One of these three methods is to disassemble the engine, to clean and to decarbonize every component of the engine, and to reassemble the engine after all components have been cleaned and decarbonized. However, this method is relatively time-consuming.

Another method for engine decarbonization is to add an appropriate amount of fuel additive into the engine fuel for engine decarbonization during operation of the engine. Nevertheless, it is hard to determine an appropriate proportion of the fuel additive to the fuel since the fuel is stored in a fuel tank and it is hard to know an exact amount of the fuel in the fuel tank. Further, the fuel additive may result in gelatinization of the fuel, abrasion of inner components of the engine, and increased operating temperature of the engine, so that rubber components of the engine (e.g., an oil seal) may undesirably age and be damaged.

Yet another method for engine decarbonization is to add a decarbonization agent directly into an engine for engine decarbonization during operation of the engine. For example, the decarbonization agent is directly drawn into the engine through an intake manifold of the engine due to a negative pressure in the engine when the engine is operating, or is directly fed into the engine by an air compressor in a form of foam. After the engine decarbonization is completed, the engine oil mixed with the decarbonization agent needs to be drawn out from the engine and replaced with clean engine oil, and such replacement of the engine oil is a complicated procedure.

In addition, the fuel additive added into the fuel for engine decarbonization and the decarbonization agent fed into the engine for engine decarbonization are generally chemical compositions that will release chemical substances, which are harmful to human bodies and the environment, due to the high temperature generated by the combustion of the fuel in the engine.

Taiwanese Utility Model No. M353996 discloses a conventional decarbonization device configured to be connected to an engine for engine decarbonization. Referring to FIG. 1, the conventional decarbonization device includes an oxyhydrogen generating unit 11 configured to electrolytically convert an electrolyte into oxyhydrogen gas, a water vapor generating unit 12 configured to generate water vapor, and a conduit unit 13 fluidly connecting the oxyhydrogen generating unit 11 and the water vapor generating unit 12 to an engine 14. When the engine 14 operates in a normal state, the engine 14 has a negative pressure therein, and accordingly, the oxyhydrogen gas from the oxyhydrogen generating unit 11 and the water vapor from the water vapor generating unit 12 can be provided to the engine 14 through the conduit unit 13 for softening carbon deposits in the engine 14. Thus, engine decarbonization for the engine 14 can be implemented effectively.

However, since temperature of the electrolyte may rise upon electrolytically converting the electrolyte into the oxyhydrogen gas, the electrolyte may vaporize into water vapor. As a result, an excessive amount of water vapor will be fed into the engine, and may lead to short circuit of electronic components and even prevent the engine from operating normally.

### SUMMARY OF THE INVENTION

Therefore, an object of the present invention is to provide a decarbonization device for engine decarbonization that is capable of reducing an amount of water vapor fed into an engine.

Accordingly, a decarbonization device of the present invention is configured to be connected to an engine for engine decarbonization. The decarbonization device comprises an oxyhydrogen supplying unit, a dryer unit connected to the oxyhydrogen supplying unit, an exhaust unit connected to the dryer unit, and a pressure adjusting unit connected to the exhaust unit.

The oxyhydrogen supplying unit is configured to supply oxyhydrogen gas, and the dryer unit is configured to dry the oxyhydrogen gas from the oxyhydrogen supplying unit. The exhaust unit is configured to be connected to the engine for providing the oxyhydrogen gas from the oxyhydrogen supplying unit through the dryer unit to the engine. The pressure adjusting unit is configured to provide air into the engine through the exhaust unit so as to adjust inner pressure within the engine.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional decarbonization device disclosed in Taiwanese Utility Model No. M353996;

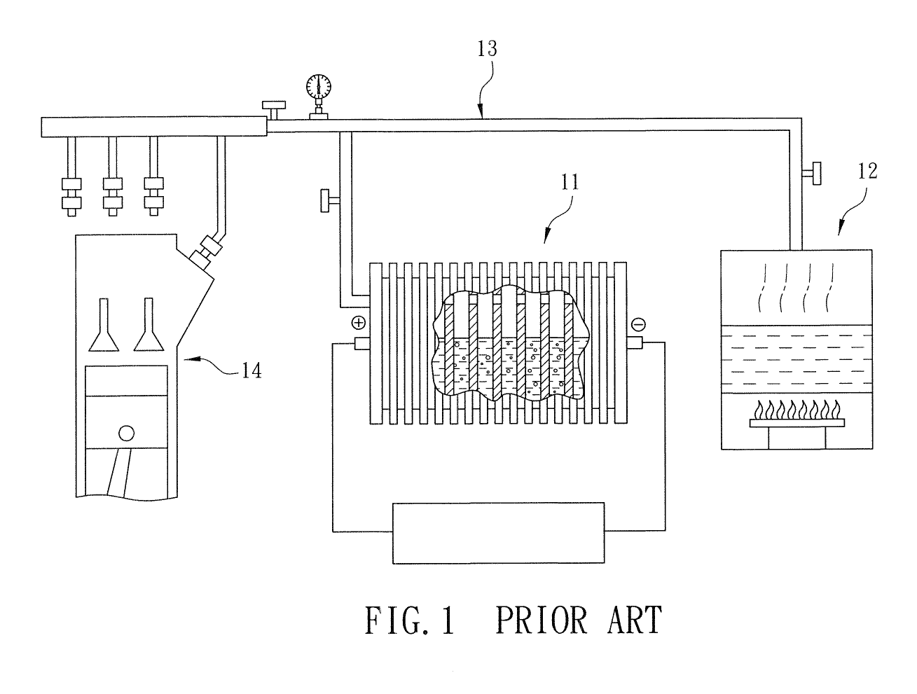

FIG. 2 is a schematic diagram of a first preferred embodiment of a decarbonization device applied to an engine of a car according to this invention;

FIG. 3 is a schematic diagram illustrating components of the decarbonization device of the first preferred embodiment;

FIG. 4 is a schematic diagram of a second preferred embodiment of a decarbonization device of the present invention; and

FIGS. 5 and 6 are plots showing the effect on reduction of pollutants by use of the decarbonization device of the present invention.

### DETAILED DESCRIPTION OF THE PREFERRED EMBODIMENTS

Before the present invention is described in greater detail, it should be noted that like elements are denoted by the same reference numerals throughout the disclosure.

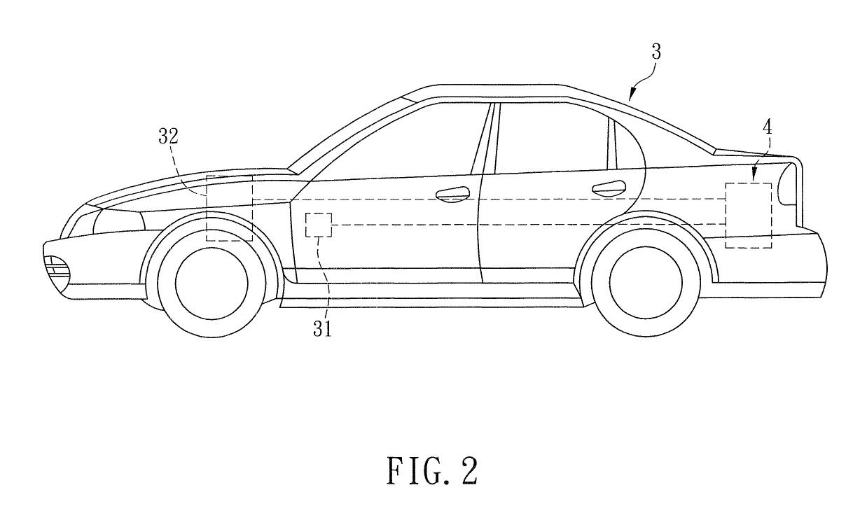

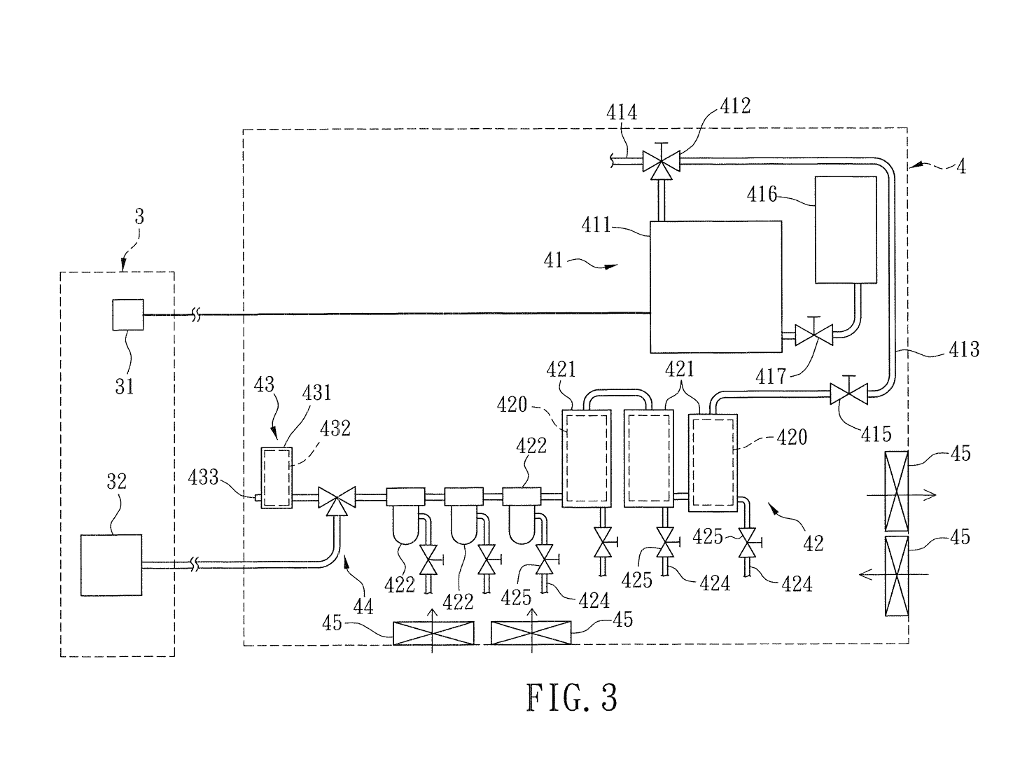

Referring to FIGS. 2 and 3, the first preferred embodiment of a decarbonization device 4 according to this invention is configured to be connected to an engine 32 of a power machine 3 so that oxyhydrogen gas can be provided from the decarbonization device 4 to the engine 32 for engine decarbonization. The power machine 3 is illustrated as, but is not limited to, a car, and may be a motorcycle, a ship, a lawn mower, or other machines having an engine in other applications. In this embodiment, the decarbonization device 4 is electrically connected to an electric power supply 31 of the power machine 3, and includes an oxyhydrogen supplying unit 41, a dryer unit 42 connected to the oxyhydrogen supplying unit 41, an exhaust unit 44 connected to the dryer unit 42, a pressure adjusting unit 43 connected to the exhaust unit 44, and a plurality of heat dissipators 45 disposed adjacent and around the dryer unit 42.

The oxyhydrogen supplying unit 41 is configured to supply the oxyhydrogen gas for the engine decarbonization, and the dryer unit 42 is configured to dry the oxyhydrogen gas from the oxyhydrogen supplying unit 41. The exhaust unit 44 is connected to the engine 32 for providing the oxyhydrogen gas from the oxyhydrogen supplying unit 41 through the dryer unit 42 to the engine 32. The pressure adjusting unit 43 is configured to provide air into the engine 32 through the exhaust unit 44 so as to adjust inner pressure within the engine 32. The heat dissipators 45 are configured to dissipate heat from the dryer unit 42.

The oxyhydrogen supplying unit 41 includes an electrolyte conversion chamber 411 for receiving an electrolyte, a three-way valve 412 connected to the electrolyte conversion chamber 411, a conduit 413 connected between the three-way valve 412 and the dryer unit 42, an exhaust pipe 414 connected to the three-way valve 412 and in fluid communication with the ambient, a first control valve 415 disposed on the conduit 413, a supplementary container 416 connected to the electrolyte conversion chamber 411, and a second control valve 417 disposed between the electrolyte conversion chamber 411 and the supplementary container 416. The electrolyte conversion chamber 411 is electrically connected to the electric power supply 31 of the power machine 3 for electrolytically converting the electrolyte into the oxyhydrogen gas, and the conduit 413 is configured to allow the oxyhydrogen gas to flow from the electrolyte conversion chamber 411 to the dryer unit 42 therethrough. The three-way valve 412 is operable to control the flow of the oxyhydrogen gas from the electrolyte conversion chamber 411 toward the conduit 413 or the exhaust pipe 414. The supplementary container 416 is configured to receive a supplementary electrolyte, and the second control valve 417 is operable to allow the supplementary electrolyte stored in the supplementary container 416 to be provided to the electrolyte conversion chamber 411.

It should be noted that, before performing the engine decarbonization, the oxyhydrogen supplying unit 41 will pre-operate in a warm-up mode, where the electrolyte conversion chamber 411 starts generating the oxyhydrogen gas and the three-way valve 412 allows the oxyhydrogen gas thus generated to flow only into the exhaust pipe 414 so that the oxyhydrogen gas will be released to the ambient through the exhaust pipe 414. When the electrolyte conversion chamber 411 operates to generate the oxyhydrogen gas stably, the three-way valve 412 allows the oxyhydrogen gas to flow into the conduit 413 for the engine decarbonization process. Further, the first control valve 415 is closed so as to prohibit the oxyhydrogen gas flowing into the dryer unit 42 when the oxyhydrogen supplying unit 41 operates in the warm-up mode. By virtue of the three-way valve 412 and the first control valve 415, the oxyhydrogen gas will not be fed into the engine 32 during the warm-up mode. In other embodiments, the oxyhydrogen supplying unit 41 may only include one of the three-way valve 412 and the first control valve 415 for prohibiting the oxyhydrogen gas from being fed into the engine 32 during the warm-up mode. Since the three-way valve 412 and the first control valve 415 are well known in the art, details thereof will be omitted herein for the sake of brevity.

In this embodiment, the dryer unit 42 includes a plurality of filters 421 connected to each other in series and in fluid communication with the electrolyte conversion chamber 411, and a plurality of water vapor separators 422 connected to each other in series and in fluid communication with the filters 421 for separating water vapor from the oxyhydrogen gas. Each of the filters 421 has a filtering layer 420 that is disposed therein and that comprises activated carbon and a porous medium (e.g., a sponge), and each of the filters 421 and the water vapor separators 422 is provided with a drain pipe 424 connected thereto and a drain valve 425 disposed on the drain pipe 424.

Since temperature of the electrolyte stored in the electrolyte conversion chamber 411 may rise upon electrolytically converting the electrolyte into the oxyhydrogen gas, the electrolyte may vaporize into water vapor, and thus, the oxyhydrogen gas from the oxyhydrogen supplying unit 41 may contain an excessive amount of water vapor. There is a negative pressure generated in the engine 32 when the engine 32 operates such that the oxyhydrogen gas with the water vapor from the oxyhydrogen supplying unit 41 is carried into the dryer unit 42 through the conduit 413. Then, the filtering layers 420 of the filters 421 may reduce the temperature of the oxyhydrogen gas from the oxyhydrogen supplying unit 41 since the temperature of the filtering layers 420 of the filters 421 is lower than the temperature of the oxyhydrogen gas. Therefore, a part of the water vapor in the oxyhydrogen gas forms relatively large particles of water drops that will be separated from the oxyhydrogen gas in the filters 421. Further, the water vapor separators 422 are configured to absorb relatively small particles of moisture in the oxyhydrogen gas that has passed through the filters 421. In addition, in order to ensure the capability of the dryer unit 42 for separating the water from the oxyhydrogen gas from the oxyhydrogen supplying unit 41, the drain valves 425 are operable to drain out the water, which was separated from the oxyhydrogen gas in the filters 421 and the water vapor separators 422 and accumulates therein, through the drainpipe 424 of each of the filters 421 and the water vapor separators 422 so as to free the filters 421 and the water vapor separators 422 from an excessive amount of water accumulating therein.

Moreover, the heat dissipators 45 are operable to cool down the filters 421 and the water vapor separators 422 that are heated up by the oxyhydrogen gas with high temperature so as to ensure the desired effect of the dryer unit 42 on drying the oxyhydrogen gas. In this embodiment, each of the heat dissipators 45 is, for example, a fan configured to generate air flow passing through the dryer unit 42 for cooling down the dryer unit 42.

Therefore, the oxyhydrogen gas provided to the engine 32 through the exhaust unit 44 connected thereto is relatively dry. There is a negative pressure generated in the engine 32 when the engine 32 operates so that the oxyhydrogen gas is directly fed into the engine 32 through the exhaust unit 44 due to the negative pressure in the engine 32. The pressure adjusting unit 43 is configured to provide air into the engine 32 to adjust the inner pressure within the engine 32 so as to prevent the electrolyte stored in the electrolyte conversion chamber 411 from being drawn into the engine 32 and to prevent the electrolyte conversion chamber 411 from deformation attributed to an extreme negative pressure within the engine 32. In this embodiment, the pressure adjusting unit 43 includes a casing 431 formed with an opening 433 so as to provide ambient air into the engine 32, and a porous filtering medium 432 (e.g., a sponge) disposed in the casing 431 for filtering the ambient air.

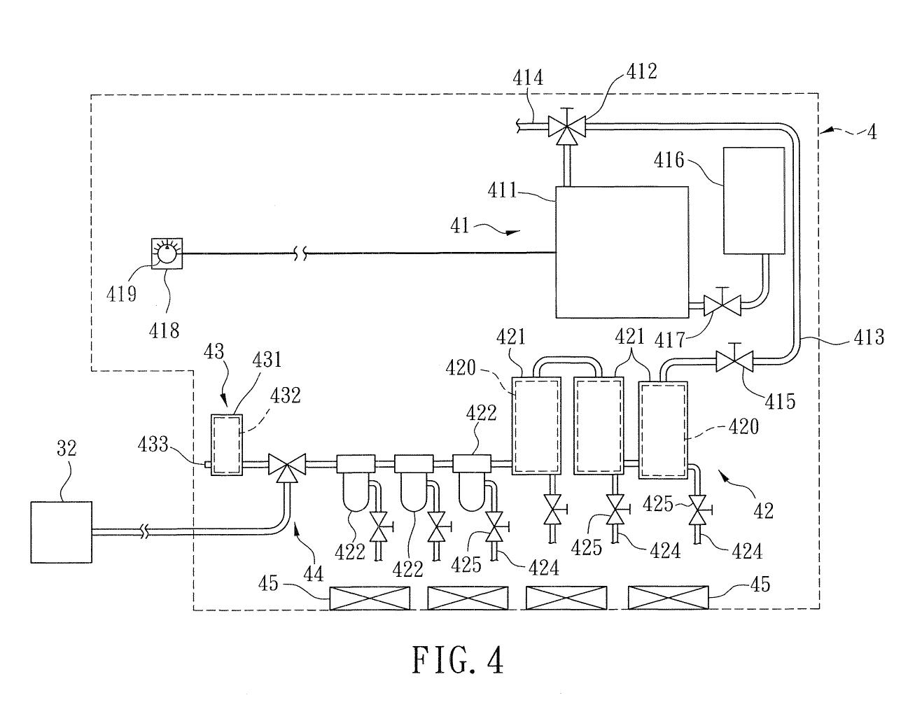

Referring to FIG. 4, the second preferred embodiment of a decarbonization device 4 according to this invention is similar to the first preferred embodiment. In this embodiment, the oxyhydrogen supplying unit 41 of the decarbonization device 4 further includes an electric power supply 418 electrically connected to the electrolyte conversion chamber 411 for providing electric power thereto. In particular, the electric power supply 418 includes a current adjustor 419 operable to adjust magnitude of an electric current of the electric power provided to the electrolyte conversion chamber 411 so as to control the electrolyte conversion chamber 411 to generate the oxyhydrogen gas at a desired rate. When the electric current of the electric power provided to the electrolyte conversion chamber 411 is relatively greater, the electrolyte conversion chamber 411 is operable to electrolytically convert the electrolyte into the oxyhydrogen gas at a relatively higher rate and to generate a relatively greater amount of the oxyhydrogen gas such that the engine decarbonization is relatively efficient.

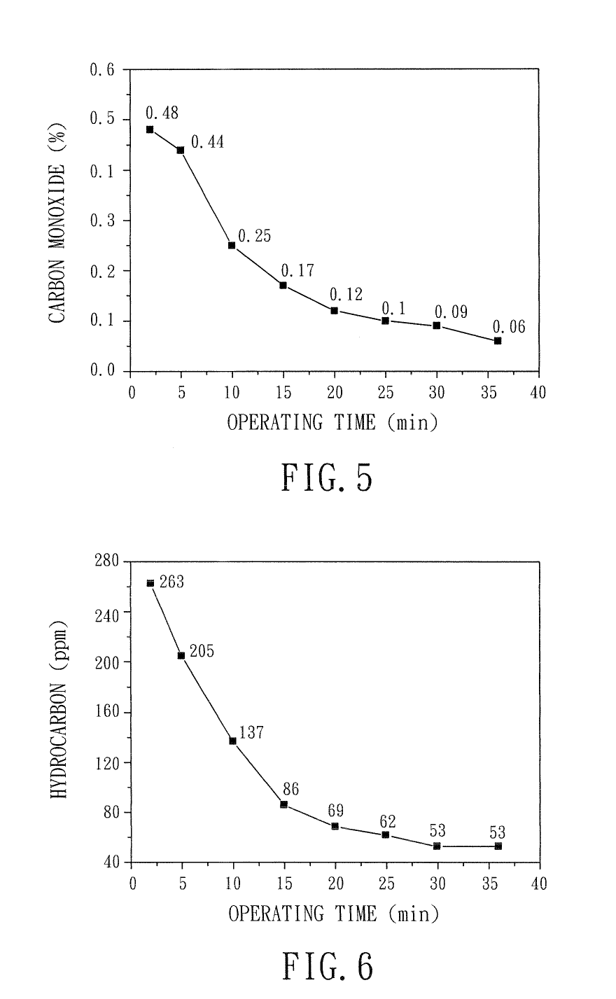

In order to prove the effect of the decarbonization device 4 according to this invention, a test was performed on the engine of a first test vehicle (Toyota Corona, 1992) to measure amounts of carbon monoxide and hydrocarbon discharged from the engine. Referring to Table 1 and FIGS. 5 and 6, the amounts of carbon monoxide and hydrocarbon discharged from the engine are gradually reduced when the decarbonization device 4 operates continuously. That is to say, the decarbonization device 4 is certainly capable of reducing an amount of pollutants discharged from an engine. Further, Table 2 shows the fuel consumption of a second test vehicle (Ford Escape, 2004), and Table 3 shows the fuel consumption of the same after using the decarbonization device 4 for engine decarbonization on the engine thereof. From Tables 2 and 3, it should be appreciated that an average amount of fuel consumption of the engine of the second test vehicle is about 9.9 kilometer per liter before the engine decarbonization, and about 11.05 after the engine decarbonization. Certainly, the decarbonization device 4 is capable of reducing the fuel consumption of an engine.

TABLE 1

| | | Operating Time (min) | | | | | | | Reduction |
|---|---|---|---|---|---|---|---|---|---|
| Item | Before | 5 | 10 | 15 | 20 | 25 | 30 | After | Ratio |
| CO (%) | 0.48 | 0.44 | 0.25 | 0.17 | 0.12 | 0.10 | 0.09 | 0.06 | 81% |
| HC (ppm) | 263 | 205 | 137 | 86 | 69 | 62 | 53 | 53 | 210 |

TABLE 2

| | Fuel | Traveled | Kilometer | |
|---|---|---|---|---|
| Odometer | Consumption | Distance | per Liter | |
| (km) | (L) | (km) | (km/L) | |
| 79553 | | | | |
| 79986 | 45.15 | 433 | 9.59 | City |
| 80438 | 43 | 452 | 10.51 | Highway |
| 80902 | 48.73 | 464 | 9.52 | City |
| 81370 | 44.87 | 468 | 10.43 | Highway |
| 81775 | 42.67 | 405 | 9.49 | City |

TABLE 3

| | Fuel | Traveled | Kilometer | |
|---|---|---|---|---|
| Odometer | Consumption | Distance | per Liter | |
| (km) | (L) | (km) | (km/L) | |
| 81775 | | | | |
| 82320 | 44.81 | 545 | 12.16 | Highway |
| 82823 | 43.86 | 503 | 11.46 | Highway |
| 82384 | 44.67 | 461 | 10.32 | City |
| 83718 | 42.34 | 434 | 10.25 | City |
| 84115 | 36.02 | 397 | 11.02 | Highway |

To sum up, the dryer unit 42 is capable of drying the oxyhydrogen gas from the oxyhydrogen supplying unit 41, and thus, the amount of the water vapor fed into the engine 32 is significantly reduced to a level that will not affect operation and service life of the engine 32. Further, the pressure adjusting unit 43 is capable of providing air into the engine 32 to adjust the inner pressure within the engine 32 so as to prevent the electrolyte conversion chamber 411 from deformation attributed to an extreme negative pressure within the engine 32.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A decarbonization device configured to be connected to an engine for engine decarbonization, said decarbonization device comprising:
an oxyhydrogen supplying unit for supplying oxyhydrogen gas;
a dryer unit connected to said oxyhydrogen supplying unit for drying the oxyhydrogen gas from said oxyhydrogen supplying unit;
an exhaust unit connected to said dryer unit and configured to be connected to the engine for providing the oxyhydrogen gas from said oxyhydrogen supplying unit through said dryer unit to the engine; and
a pressure adjusting unit connected to said exhaust unit for providing air into the engine through said exhaust unit so as to adjust inner pressure within the engine.

2. The decarbonization device as claimed in claim 1, wherein said dryer unit includes at least one filter having a filtering layer that is disposed therein and that comprises activated carbon and a porous medium.

3. The decarbonization device as claimed in claim 2, wherein:
said dryer unit further includes at least one water vapor separator in fluid communication with said filter for separating water vapor from the oxyhydrogen gas;
each of said filter and said water vapor separator is provided with a drain pipe connected thereto and a drain valve that is disposed on said drain pipe and that is operable to drain water separated from the oxyhydrogen gas through said drain pipe; and
said decarbonization device further comprises at least one heat dissipator disposed adjacent to said dryer unit for dissipating heat from said filter and said water vapor separator.

4. The decarbonization device as claimed in claim 3, wherein said heat dissipator is a fan.

5. The decarbonization device as claimed in claim 1, wherein said pressure adjusting unit includes a casing formed with an opening so as to provide ambient air into the engine, and a porous filtering medium disposed in said casing for filtering the ambient air.

6. The decarbonization device as claimed in claim 1, wherein said oxyhydrogen supplying unit includes an electrolyte conversion chamber that is for receiving an electrolyte and that is operable to electrolytically convert the electrolyte into the oxyhydrogen gas.

7. The decarbonization device as claimed in claim 6, wherein said oxyhydrogen supplying unit further includes a three-way valve connected to said electrolyte conversion chamber, a conduit connected between said three-way valve and said dryer unit and allowing the oxyhydrogen gas to flow from said electrolyte conversion chamber to said dryer unit therethrough, and an exhaust pipe connected to said three-way valve and in fluid communication with the ambient, said three-way valve being operable to control the flow of the oxyhydrogen gas from said electrolyte conversion chamber toward one of said conduit and said exhaust pipe.

8. The decarbonization device as claimed in claim 7, wherein said oxyhydrogen supplying unit further includes a control valve disposed on said conduit for controlling the flow of the oxyhydrogen gas from said electrolyte conversion chamber toward said dryer unit through said conduit.

9. The decarbonization device as claimed in claim 6, wherein said oxyhydrogen supplying unit further includes an electric power supply electrically connected to said electrolyte conversion chamber for providing electric power thereto.

10. The decarbonization device as claimed in claim 9, wherein said electric power supply includes a current adjustor operable to adjust magnitude of an electric current of the electric power provided to said electrolyte conversion chamber.

11. The decarbonization device as claimed in claim 9, further comprising at least one heat dissipator disposed adjacent to said dryer unit for dissipating heat therefrom.

12. The decarbonization device as claimed in claim 11, wherein said heat dissipator is a fan.
